(19) United States
(12) Patent Application Publication
(10) Pub. No.: US 2017/0188318 A1
(43) Pub. Date: Jun. 29, 2017

(54) COMMUNICATIONS CHANNEL HANDOVER IN A DISTRIBUTED ANTENNA SYSTEM (DAS) TO AVOID OR MITIGATE SERVICE DISCONNECTION

(71) Applicant: Corning Optical Communications Wireless Ltd, Airport City (IL)

(72) Inventor: Dror Harel, Hod Hasharon (IL)

(21) Appl. No.: 15/459,331

(22) Filed: Mar. 15, 2017

Related U.S. Application Data
(63) Continuation of application No. PCT/IL2015/050990, filed on Oct. 6, 2015.
(60) Provisional application No. 62/060,121, filed on Oct. 6, 2014.

(51) Int. Cl. H04W 52/40; H04W 36/06; H04W 52/24; H04W 36/24

(52) U.S. Cl. CPC H04W 52/40; H04W 36/24; H04W 36/06; H04W 52/243; H04W 84/18

(57) ABSTRACT

Communications channel handover in a distributed antenna system (DAS) to avoid or mitigate service disconnection is disclosed. In this regard, in one exemplary embodiment, a method for triggering channel handoffs in a DAS is provided. The method comprises routing a first channel of a communications service to a predetermined area in the DAS at a predetermined power level. The first channel provides a service to at least one network terminal in the predetermined area in the DAS. The method also comprises routing a second channel of a communications service to the predetermined area in the DAS. The method also comprises lowering a power level of the first channel to trigger handoff of the service to the at least one network terminal from the first channel to the second channel.

### CROSS-REFERENCE TO RELATED APPLICATION

This application is a continuation of International Application No. PCT/IL2015/050990 filed on Oct. 6, 2015 which claims the benefit of priority under 35 U.S.C. §119 of U.S. Provisional Application Ser. No. 62/060,121 filed on Oct. 6, 2014, the contents of which are relied upon and incorporated herein by reference in their entireties.

### BACKGROUND

The technology of this disclosure relates generally to reliability of digital and analog distributed antenna systems (DAS), and more particularly to communications channel handover in a DAS to avoid or mitigate service disconnection.

Wireless communications services are expanding rapidly into an ever-wider array of communications media. WiFi or wireless fidelity systems, for example, are now commonplace and being used in a variety of commercial and public settings, such as homes, offices, shops, malls, libraries, airports, and the like. Distributed antenna systems are commonly used to improve coverage and communication of WiFi communication systems. Distributed antenna systems typically include a plurality of spatially separated antennas. The distributed antennas systems communicate with a variety of such commercial communications systems to distribute their services to clients within range of the distributed antenna system.

One approach to deploying a distributed antenna system involves the deployment in a location of multiple radio frequency (RF) antenna coverage areas, such as multiple access points, also referred to as “antenna coverage areas.” Antenna coverage areas can have a radius in a range from a few meters up to twenty meters, as an example. Combining a number of access point devices creates an array of antenna coverage areas within the location. Because each of the antenna coverage areas covers a small area, there are typically only a few users (clients) per antenna coverage area. This allows for minimizing the amount of RF bandwidth shared among the wireless system users. It may be desirable to provide antenna coverage areas in many locations of a building or throughout a building or other facility to provide distributed antenna system access to clients within the building or facility.

These distributed antenna systems provide efficient distribution of communications services to clients, or a set of client devices, in a desired area of a location, such as a building or an array of buildings. Within the client area, distribution of the communications services may be provided by an internal distribution network that is a part of the DAS. The network may include optical fibers and conventional wired cables for distributing a variety of communications services. The more widely these services are distributed, the greater the chance for deterioration of services or a failure. Deterioration of services may occur when more users are making traffic demands on the bandwidth available to the coverage area or existing users are making heavier traffic demands on the bandwidth. Extensive traffic demands on the bandwidth may degrade the Quality of Service (QoS) or Quality of Experience (QoE) of mobile users. QoS and QoE may also suffer due to co-channel interference. Of course, services also may suffer when equipment or software fails. All these factors can contribute to deterioration or unreliability of communications services.

A DAS may not control a base station or a network terminal. But the DAS may create conditions to optimize system performance to which the base station and the network terminal may respond.

There is a need for improvement in system performance of a DAS. Allowing frequency changes in an area in the DAS without disconnecting service to a network terminal may be needed or desired.

No admission is made that any reference cited herein constitutes prior art. Applicant expressly reserves the right to challenge the accuracy and pertinency of any cited documents.

### SUMMARY

Aspects disclosed herein include communications channel handover in a distributed antenna system (DAS) to avoid or mitigate service disconnection. In this regard, in one exemplary embodiment, a method for triggering channel handoffs in a DAS is provided. The method comprises routing a first channel of a communications service to a predetermined area in the DAS at a predetermined power level. The first channel provides a service to at least one network terminal in the predetermined area in the DAS. The method also comprises routing a second channel of a communications service to the predetermined area in the DAS. The method also comprises lowering a power level of the first channel to trigger handoff of the service to the at least one network terminal from the first channel to the second channel.

Another embodiment of the disclosure relates to a DAS. The DAS comprises a router configured for routing a plurality of channels of a communications service to a predetermined area in the DAS. The router is also configured to route a first channel to a predetermined area at a predetermined power level. The first channel provides a service to at least one network terminal in the predetermined area in the DAS. The router is also configured to, upon command, route a second channel of a communications service to the predetermined area in the DAS. The DAS also comprises a controller configured for controlling the routing of the plurality of channels of service and for controlling lowering a power level of the first channel to trigger handoff of the service to the at least one network terminal from the first channel to the second channel.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiments and, together with the description, serve to explain principles and operation of the various embodiments.

### BRIEF DESCRIPTION OF THE DRAWINGS

FIG. 1 is a schematic diagram of an exemplary distributed antenna system (DAS) configured to distribute analog and/or digital communications signals within an installation, such as a building;

FIG. 2 is an alternate schematic diagram of a DAS for providing a plurality of communications services to a plurality of users;

FIG. 3A is a schematic diagram illustrating exemplary splitting of communications cells in a cellular network;

FIG. 3B is a schematic diagram illustrating exemplary mitigating communications service deterioration caused by co-channel interference;

FIG. 4 is a schematic diagram of another exemplary DAS;

FIG. 5 is a schematic diagram of another exemplary DAS;

FIG. 6 illustrates an exemplary process in the DAS in FIG. 5 in which a degradation of spectral efficiency, degradation of the Quality of Service (QoS) and Quality of Experience (QoE) to users in the system, co-channel interferences, or interruption of the communications has been detected and a process of switching services away from Channel 2 has begun;

FIG. 7 illustrates the DAS in FIG. 5 in which the switching of services away from Channel 2 to Channel 1 has been completed;

FIG. 8 is a schematic diagram of another embodiment of a DAS according to this disclosure;

FIG. 9 illustrates an exemplary process in the DAS in FIG. 8 in which a degradation of spectral efficiency, degradation of the QoS and QoE to users in the system, co-channel interferences, or interruption of the communications of Channel 2 has been detected and a process of switching services away from Channel 2 has begun;

FIG. 10 illustrates an exemplary process in the DAS in FIG. 8 in which the switching of services away from Channel 2 to Channel 1 has been completed;

FIG. 11 is a flowchart illustrating an exemplary process of routing a first channel and a second channel to trigger handoff of a communications service from the first channel to the second channel in a DAS; and

FIG. 12 is a flowchart illustrating another exemplary process for channel handoff in a DAS.

### DETAILED DESCRIPTION

Aspects disclosed herein include communications channel handover in a distributed antenna system (DAS) to avoid or mitigate service disconnection. In this regard, in one exemplary embodiment, a method for triggering channel handoffs in a DAS is provided. The method comprises routing a first channel of a communications service to a predetermined area in the DAS at a predetermined power level. The first channel provides a service to at least one network terminal in the predetermined area in the DAS. The method also comprises routing a second channel of a communications service to the predetermined area in the DAS. The method also comprises lowering a power level of the first channel to trigger handoff of the service to the at least one network terminal from the first channel to the second channel.

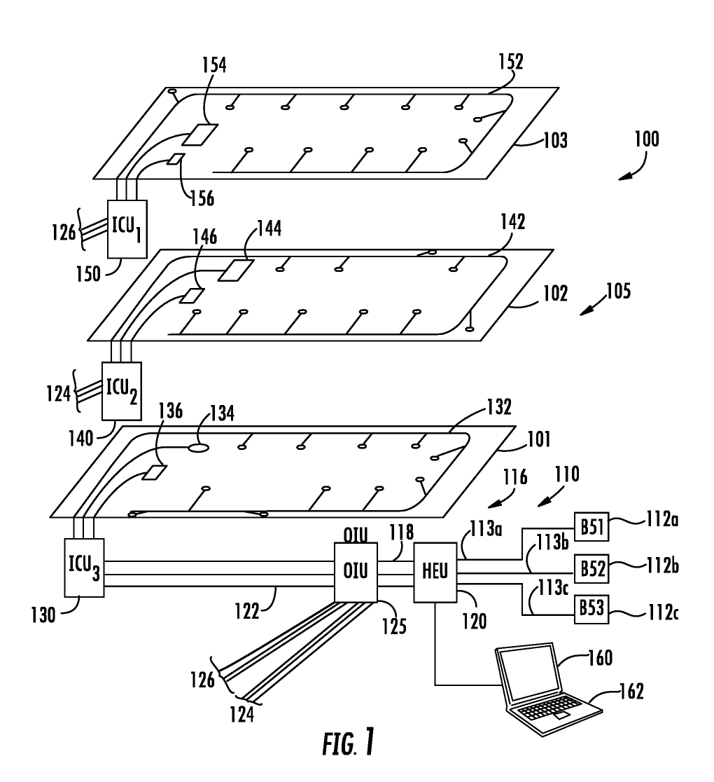

In this regard, FIG. 1 depicts an example of a distributed antenna system (DAS) 100 for a first floor 102, a second floor 104, and a third floor 106 of a building 108. In this example a plurality of communications services 110 are provided, such communications coming from first, second, and third base stations 112a, 112b, 112c, respectively, over cables 114a, 114b, 114c respectively. A DAS is an antenna system that includes a plurality of spatially separated antennas each providing a communications services communication area to support distribution of communications services between client devices and a communications network communicatively coupled to the DAS. A “communications service” can include analog and/or digital data services including but not limited to Ethernet, WLAN, Worldwide Interoperability for Microwave Access (WiMax), Radio over Fiber (RoF), Wireless Fidelity (WiFi), PCS band, 2G, 3G, 4G, GSM, Digital Subscriber Line (DSL), and Long Term Evolution (LTE), etc., as non-limiting examples. In this example, the services are input to a head end unit (HEU) 120 for routing through DAS 100. The HEU 120 may include a plurality of radio distributors/combiners/splitters (RDCs) and a switching matrix for combining a plurality of communications signals into a broadband signal for further transmission, such as to an optical input unit, and for splitting a broadband signal from an optical input unit into individual communications signals, thus allowing two-way communications.

With continuing reference to FIG. 1, the DAS 100 is controlled by a computer 160 with operator input device 162. The computer may include local memory and may have access to remote memory, as well as computer programs stored on at least one non-transitory medium, either locally or remotely. The computer 160 may be connected directly to the HEU 120 and may be in control of other elements of the DAS 100 via wired connections or remotely, as shown. The computer 160 may also control an optical interface unit (OIU) 128.

The communication services are illustratively routed through DAS 100 as shown in FIG. 1. Cable or hard wire outputs 118 from the HEU 120 may connect to the optical interface unit 128 and then to interconnect units (ICUs) 130, 140, 150 for serving the first, second and third floors 102, 104, 106, respectively, of building 108. Interconnect units 130, 140, 150 interface with mechanical and/or power mediums 122 to provide communications and/or power distribution to remote antenna units (RAUs) 164.

The computer 160 may be used to control the HEU 120, the optical interface unit 128 and the interconnect units 130, 140, 150 of the DAS 100. The computer 160 may also control or monitor switches and switch matrices of the HEU 120 and OIU 128 useful in operation of distributed antenna systems. The computer may be supplied with a non-transitory memory and a computer program useful for routing the signals through the system.

Within each floor 102, 104, 106, the services are then provided separately, as shown. Thus, the first floor 102 may be provided, through its interconnect unit 130, with an Ethernet wire distribution 132, a Wi-Fi hot spot 134, and a telecommunications antenna 136. In this example, similar services may be provided to the second and third floors 104, 106, through their interconnect units 140, 150 with Ethernet lines 142, 152, Wi-Fi hot spots 144, 154 and telecommunications antennas 146, 156.

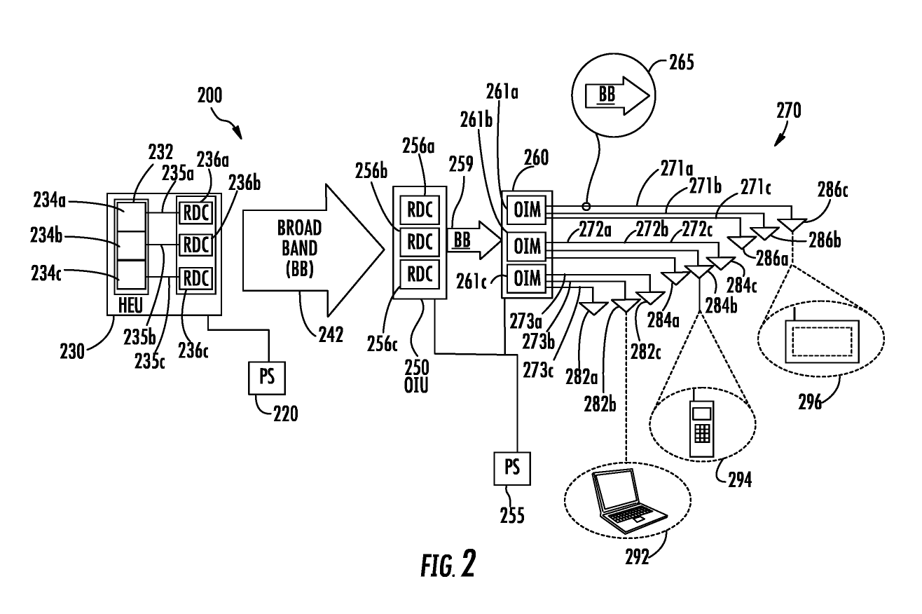

FIG. 2 is an alternative embodiment of a DAS 200. In this view, HEU 202 receives communications services inputs 204a, 204b, 204c which are applied over cables 206a, 206b, 206c to a plurality of radio distributor combiners/splitters (RDCs) 208a, 208b, 208c. These services are provided by base stations of service providers (not shown). The HEU 202 may also include a power supply or power source 220. The HEU 202 includes the plurality of RDCs 208a, 208b, 208c for combining the signals into a broadband output signal 212 in one direction. RDCs may be RDC cards, e.g., circuit boards with the appropriate functions well known in the art. The RDCs also provide for splitting of a broadband input in the other direction. In other words, the RDCs split the broadband signal into its narrow band component parts for transmission in the opposite direction, thereby allowing for two-way communication.

With continued reference to FIG. 2, the broadband signal 212 is transmitted via cable (shown as cable 118 in FIG. 1) to the optical interface unit 214, which may also be equipped with a power source or power supply 216. Optical interface unit 214 includes a second plurality of RDCs 216a, 216b, 216c, which may be RDC cards, e.g., circuit boards with the appropriate functions well known in the art. In this embodiment, the RDC cards of the optical interface unit 214 typically do not perform signal combining or splitting, although they may be capable of such action. The optical interface unit 214 passes a broadband electrical signal 218 to a plurality of optical input modules (OIMs) 220a, 220b, 220c. As shown in FIG. 2, each OIM may service three remote antenna units (RAUs) with a broadband signal 222. Hence, the OIMs 220 in this embodiment may serve up to nine clients.

As shown in FIG. 2, OIM 220 has three outputs, 224a, 224b, 224c for sending broadband signal 222 to three remote antenna units (RAUs) 226, 226, 226, respectively. Each OIM 220 further has an electrical to optical (E/O) and an optical to electrical (O/E) switching pair (not shown). More specifically, the broadband electrical signal 218 that is generated by OIU 214 and applied to OIMs 220a, 220b, 220c is converted by the OIMs 220 into broadband optical signals 222 for transmission to the remote antenna units (RAUs) 226.

At the RAUs 226, the broadband optical signal 222 is converted back into an electrical signal and filtered into a narrowband electrical signal which is transmitted to the client devices. To effect the conversion of the optical signal to electrical signal and vice-versa, each RAU 226 is likewise provided with an electrical to optical (E/O) and an optical to electrical (O/E) switching pair (not shown). Hence, the broadband optical signal 222 which is applied to each RAU 226 is converted by the RAUs 226 into a filtered electrical signal for transmission to client devices 292, 294, 296 as shown. With client device 292, which is illustratively a personal computer, the RAU 226 provides the electrical signal as an Ethernet service. With client devices 294 and 296, the electrical signal is wireless. These and other ways for delivering communication services to clients through a distributed antenna service are well known in the art.

As previously described, the communication services may be narrow band electrical signals provided by service providers over different bands of frequencies such as 400 MHz to 2700 MHz frequency range, such as 400-700 MHz, 700 MHz-1 GHz, 1 GHz-1.6 GHz, and 1.6 GHz-2.7 GHz, as examples. Radio input modules may be used as part of the service input.

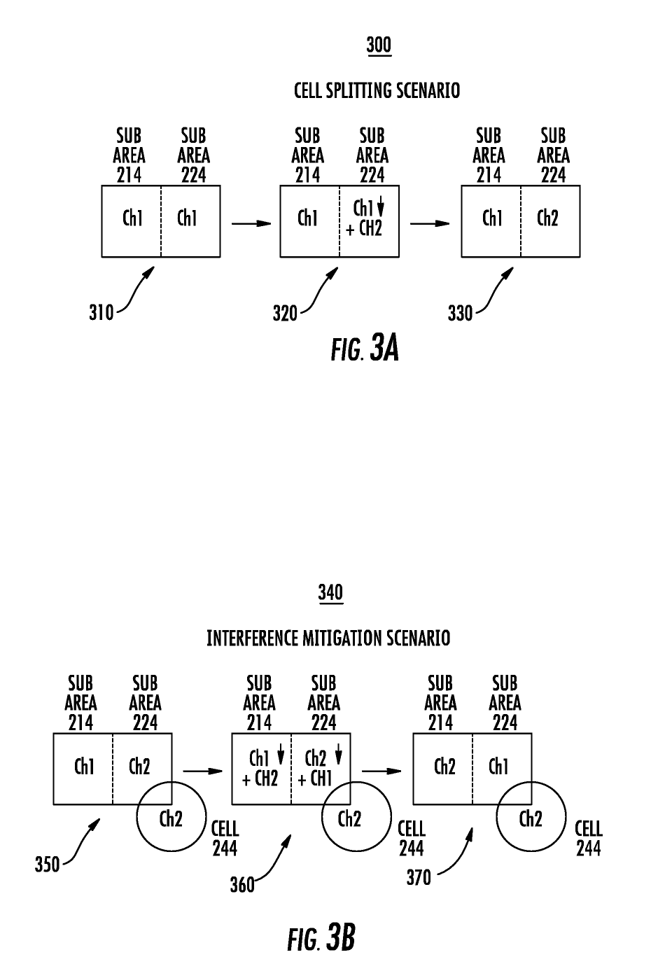

FIG. 3A depicts a cellular splitting scenario 300 for a communication service, perhaps for two floors of a building, sub areas 302(1), 302(2), which is served by a single communication service, Channel 1 (Ch. 1). The cellular splitting scenario 300 of FIG. 3A starts with a certain number of users that are making traffic demands 304 on the bandwidth available in subareas 302(1), 302(2). At some point in time, traffic demands on the available bandwidth are shown to increase and strain the capacity of Channel 1 due to more users accessing the bandwidth or existing users making heavier demands on the bandwidth. Extensive traffic demands on the bandwidth may degrade the Quality of Service (QoS) or Quality of Experience (QoE) of mobile users.

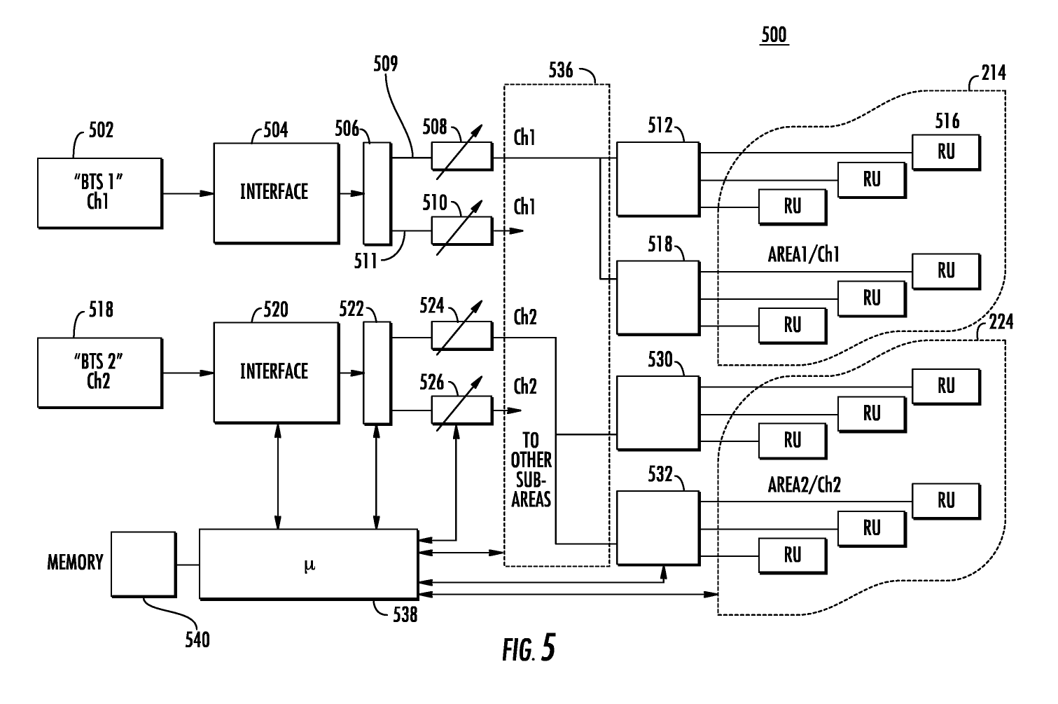

In order to continue uninterrupted service or continue service for a desired QoS and/or QoE to all served users, a second channel can be provided. This is shown by switching Channel 1 to Channel 2 (Ch. 2) in sub area 302(2) to accommodate traffic demands on the available bandwidth. With reference back to FIGS. 1-2, this second channel may be provided by adding a second channel of the communications service from broadband signal 222 (FIG. 2) that is throughput to the users through RDC 216a and OIM 220a. With reference back to FIG. 3A, as the channel change in sub area 302(2) changes, traffic demands from sub area 302(1) are serviced by Channel 1 and traffic demands from sub area 302(2) are being transitioned for service by Channel 2, as shown in the center illustration in FIG. 3A. When the transition is complete, as shown in the right-hand illustration of FIG. 3A, traffic demands 330 in sub area 302(1) are now served by Channel 1 and sub area 302(2) is now served by Channel 2. In effect, Channel 1 is taken out of service in sub area 302(2) and replaced with Channel 2. This technique may involve cell-splitting, in which a given coverage area or cell, such as the building, is split into multiple cells, where in order to meet traffic demands each cell is now served by a different source with sufficient capacity, e.g., a different base station. The base stations depicted in FIGS. 5-10 may be considered as providing the extra capacity. The RDCs and OIMs of FIGS. 1-2 deliver this capacity to building sub areas 302(1), 302(2) as described in FIGS. 1-2.

Advantageously, the DAS of this disclosure introduces the new Channel 2 into sub area 302(2) at the same time that sub area 302(2) continues to be served by Channel 1. Illustratively, the new Channel 2 may be at the same or about the same power level as the power level of Channel 1. Alternatively, the new Channel 2 may be introduced at a power level that is higher or lower than the power level of Channel 1. The DAS then gradually lowers the power of the Channel 1 to allow the network terminal to gradually initiate a handover process. When the power of Channel 1 is below a predetermined level, the handover process in the network terminal software automatically hands off the network terminal to the new Channel 2. After handoff, the DAS then disconnects Channel 1.

In a non-limiting example, the DAS provides for a two-step system and process. First, the DAS broadcasts a new Channel 2 to an area that is being served by an old Channel 1. The turn on of the broadcast of new Channel 2 need not be gradual. The broadcast of new Channel 2 is at a predetermined power level that is the same power level or close to the power level of the old Channel 1. After the broadcast is in place, the area will be served by both Channel 1 and Channel 2. However, network terminals in the area will continue to be served by old Channel 1 since the handover process of the network terminal is not yet triggered. Second, the DAS gradually powers down Channel 1. Alternatively, the DAS may gradually power up Channel 2 or both power down Channel 1 and power up Channel 2. Service on Channel 1 will be degraded until the power level of Channel 1 drops below the power level of Channel 2. At that point, the network terminal triggers a handoff of the network terminal to the new Channel 2.

In a non-limiting embodiment, the power down of Channel 1 may occur over a window of time of between five (5) and sixty (60) seconds to allow the network terminal enough time to understand that Channel 1 is degrading and a stronger Channel 2 service is available and to activate the handover process from Channel 1 to Channel 2. Shorter or longer windows of time may also be used.

Hence, the DAS forces a network terminal in the area to switch from Channel 1 to Channel 2 by broadcasting Channel 2 into the area serviced by Channel 1 and then lowering the power of Channel 1 until the handover process in the network terminal is triggered to hand over communication that is occurring between the network terminal and the DAS from Channel 1 to Channel 2. In this way, the DAS creates an environment for modifying the behavior of the mobile device even though the DAS is not controlling the network terminal or the base station to which it is connected.

FIG. 3B depicts an interference mitigation scenario 350 in which deterioration of QoS and QoE may suffer in this scenario due to co-channel interference. In this instance, the same two sub areas 302(1), 302(2) depicted in FIG. 3A are served. However, unlike in FIG. 3A where sub areas 302(1), 302(2) were served by Channel 1, in FIG. 3B, sub area 302(2) is served by Channel 2. The problem depicted in this scenario may occur when a nearby cell 352 is also served by Channel 2. This scenario may illustratively arise where services to cell 352 are delivered by a cell tower that is not part of the enterprise network that is servicing the building with the sub areas 302(1), 302(2). Alternatively, the cell tower may be part of the enterprise network but configured to provide cell services to users on the grounds surrounding the building with the sub areas 302(1), 302(2). Regardless, the overlap of cells delivering the same service, i.e., Channel 2 in this example, may cause co-channel interference. In other words, the service from cell 352 may interfere with reception and service of users of Channel 2 in sub area 302(2), creating traffic demands 354(1) as shown in the left side illustration of FIG. 3B.

This may result in interrupted service or service that is no longer of good QoS and/or QoE. In this scenario, in order to minimize co-channel interference and optimize system performance, the system switches the services delivered to sub areas 302(1), 302(2). More specifically, the service of the sub area 302(1) served by Channel 1 proceeds to be switched with the service of the sub area 302(2) served by Channel 2 to create traffic demands 354(2), as shown in the central illustration of FIG. 3B. When the switch is complete, sub area 302(1) is now served by Channel 2 and sub area 302(2) is served by Channel 1 to create traffic demands 354(3). Cell 352 continues to be served by Channel 2. As also shown in the right side illustration of FIG. 3B, co-channel interference between cell 352, in close proximity to Channel 1 users in sub area 302(2), has been minimized. Service has been switched to create traffic demands 354(3) to improve the spectral efficiency of the DAS, without degradation of the QoS and QoE to users in the system, co-channel interferences, and interruption of the communications services.

As previously explained, the DAS of this disclosure advantageously introduces the new Channel 2 into sub area 302(1) at the same time that sub area 302(1) continues to be served by Channel 1. The DAS then gradually lowers the power of the Channel 1 to allow the network terminal to gradually initiate a handover process. When the power of Channel 1 is below a predetermined level, the handover process in the network terminal software automatically hands off the network terminal to Channel 2. After handoff, the DAS then disconnects Channel 1. In this way, the DAS forces a network terminal in the area to switch between broadcasted channels in order to optimize the DAS.

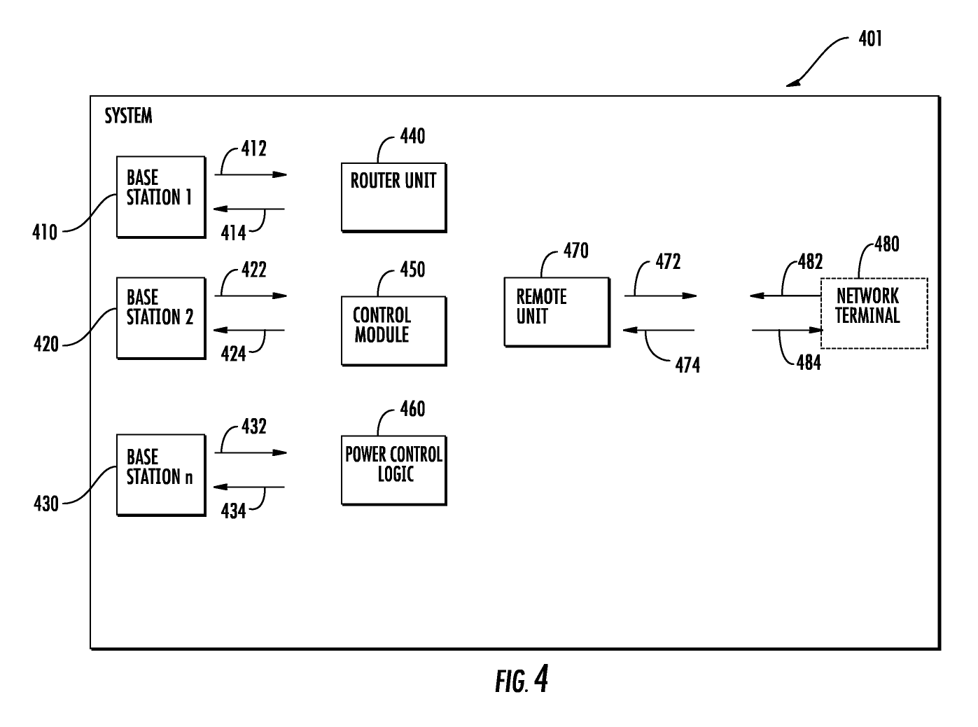

Turning now to the architecture for optimizing the DAS, FIG. 4 depicts another exemplary embodiment of a DAS 400. The DAS 400 comprises a plurality of base stations 402(1)-402(M), a router unit 404, a controller 406, a power control logic 408, and at least one remote unit (RU) 410.

The plurality of base stations 402(1)-402(M) provide a plurality of communications services. Each base station 402 is configured to transmit on a forward transmission link 412(1)-412(M) and receive on a reverse transmission link 414(1)-414(M).

The RU 410 is a device connected to an optical interface module (not shown) that converts and filters a broadband optical signal into a narrow electrical signal and vice versa. The RU is illustratively configured to set up and operate radio communication channels with one or more network terminals 416. The RU 410 includes a transmitter (not shown) configured to transmit on a forward transmission link 418 and a receiver (not shown) configured to receive on a reverse transmission link 420.

The router unit 404 is configured for routing a plurality of channels of service from the plurality of base stations 402 to the RU 410. The router unit 404 is described in greater detail below.

The controller 406 is configured for controlling the routing of the plurality of channels of service from the plurality of base stations 402(1)-402(M) to the RU 410. The controller 406 can be any microprocessor and associated executable instructions in a memory unit (not shown) capable of accessing information stored in the memory, performing actions based on instructions using information from the memory or some other source, and alternatively storing information in the memory or transmitting information. More than one processor may also be used as the controller.

The power control logic 408 includes instructions in the memory unit (not shown) executable by the controller 406 configured to determine whether to power up or power down channels. In the exemplary embodiment depicted in FIG. 4, the DAS 400 may include a mechanism that identifies that there is interference between the same channel due to overlap in coverage of the same channel broadcast from two transmitters. On identification of the interference, the DAS 400 may switch Channel 2 to Channel 1 in order to minimize the interference as previously explained.

The power control logic 408 used by the DAS 400 to determine whether to power up or power down channels may be based upon QoS. For example, a service provider may alert the DAS 400 that the QoS of Channel 1 in a part of a building is poor and to change the channel to Channel 2 which has a better QoS. Alternatively, the DAS 400 may determine what channels to power up or down based upon a self-organized network mechanism embedded into the DAS 400 based upon planning, deployment and network configuration and operational needs such as service/availability optimization. For example, the DAS 400 may configure the building to use only one channel at night and to use additional channels during the day. The DAS 400 may configure multiple channels to be used in parts of the building where there is high user traffic and one or fewer channels where the user traffic is light.

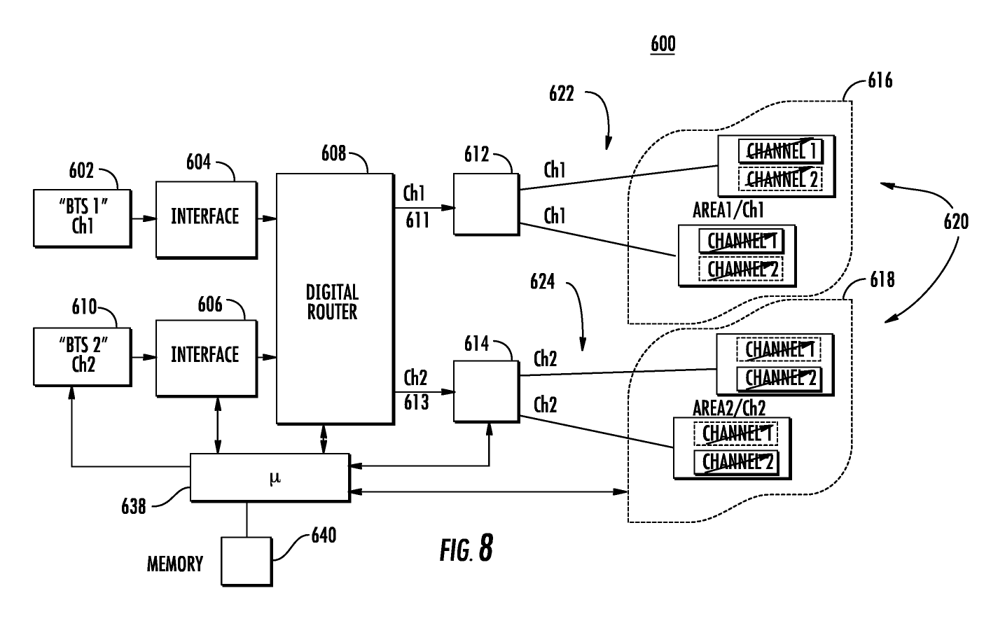

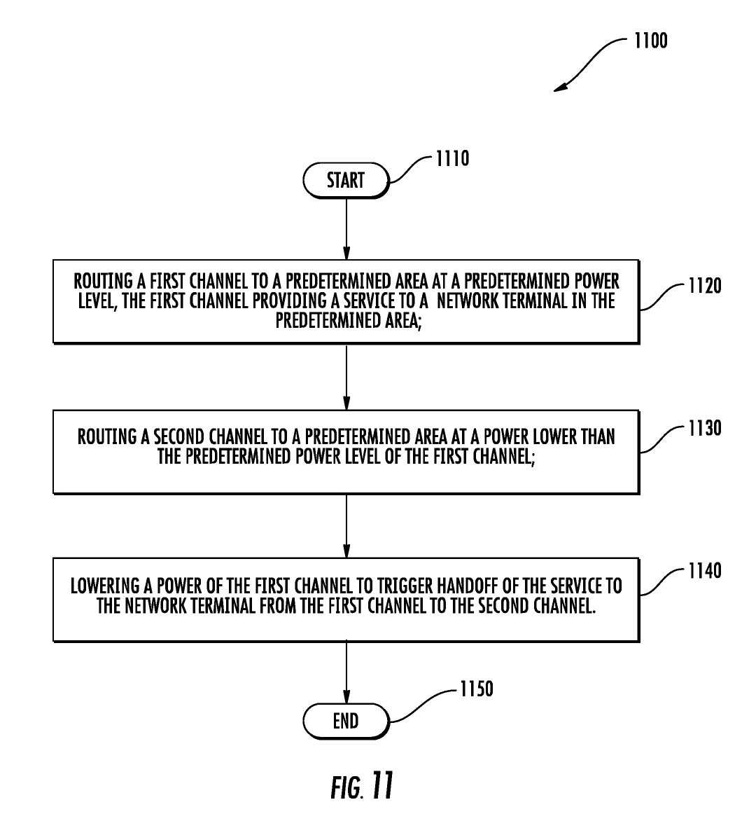

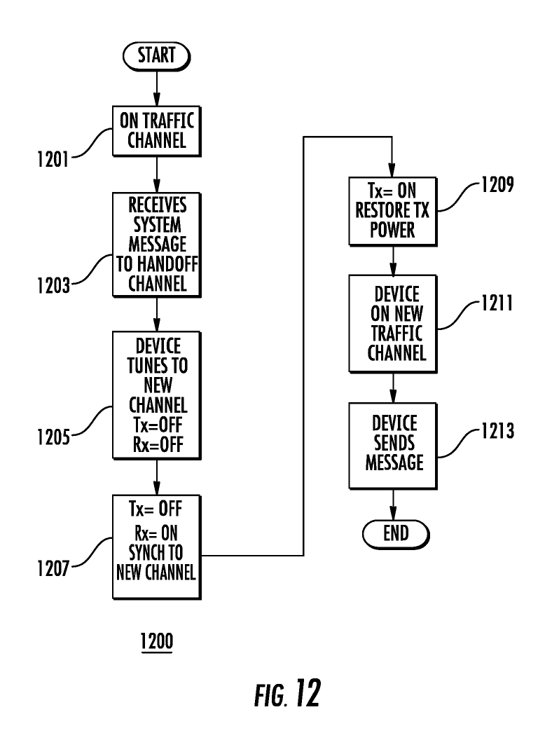

We now turn to specific examples depicted in FIGS. 5-12 for implementing the features described in connection with FIG. 4. By way of overview, FIGS. 5-7 are directed to systems that may be advantageously used with analog systems, that is, with analog remote antenna units or users of the communications services. As discussed above, these users are not digital and do not have the advantages of selecting a channel or turning to an alternate channel when service deteriorates. Typically, when service degrades or deteriorates on analog devices, tuning to or using a different band may be necessary to restore service. FIGS. 8-10 are directed to systems that may be advantageously used with digital systems. FIG. 11 is directed to an illustrative QoS logic of this disclosure. Finally, FIG. 12 depicts an illustrative method for performing a handoff according to this disclosure.

In the DAS 500 of FIG. 5, a first base station 502 provides a Channel 1 service to a plurality of remote users 504(1)-504(N) in a first end user area 302(1) and a second base station 506 provides a Channel 2 service to a plurality of remote users 508(1)-508(P) in a second end user area 302(2). The services may be any of the data or communications services discussed previously. Channel 1 service is routed through an interface 510, such as HEU 120 as seen in FIG. 1. The plurality of RDCs and a switching matrix of the HEU are configured for combining a plurality of communications signals into a broadband signal for further transmission, such as to an optical input unit, and for splitting a broadband signal from an optical input unit into individual communication signals, thus allowing two-way communications.

Channel 2 service is provided through second base station 506. The Channel 2 service may be a different communications service, or may be the same service as Channel 1 if there is a high demand for that service. Channel 2 is also routed through a HEU 120 as seen in FIG. 1. The interface 512 routes the Channel 2 service to the end users.

Channel 1 is then routed from the interface 510, in this embodiment, to a splitter 514 which may split the service and route it to a plurality of attenuators 516(1), 516(2) via pathways 518(1), 518(2). Channel 2 is also routed from its interface 512 to a splitter 520 and then to attenuators 516(3), 516(4) via similar pathways. The attenuators 516(1), 516(2) control the power level of the signals routed from the attenuators 516(1), 516(2) to the remote antenna units 504, i.e., to the receiver units or remote antenna units. The attenuators 516 for the services are thus useful in helping to transition the end users from one service or channel to another. The attenuators 516(1), 516(2) control the power level of the downlink signals for Channel 1 to the specific end user area 302(1). Switching matrix 522 routes the downlink signal for Channel 1 through distribution units 524, which may be optical input modules (OIM) for converting an electrical downlink output to optical signals and then couples them through optical fibers to remote antenna units 504 of the specific area served, e.g., sub area 302(1).

In a similar manner, Channel 2 is routed from its interface 512 to the splitter 520 and then to attenuators 516(3), 516(4) and then through switching matrix 522 to distribution units 524 for routing downlink signals for Channel 2. Distribution units 524 may be optical input modules (OIM) for converting an electrical downlink output to optical signals and then coupling the optical signals through optical fibers to remote antenna units 508 for the second area served, e.g. sub area 302(2).

The Channel 1 and Channel 2 signals are routed from their respective base stations 502, 506 to the end user areas 302(1), 302(2) and remote units 504 by the switching matrix 522. The switching matrix 522 comprises a plurality of programmable switches configured for connecting a plurality of communications services to a plurality of optical input modules (OIMs). The switching matrix is under control of the controller 526, which may be a microprocessor controller as previously described. One or more programs to manage the connections are accessible to the controller 526 and may be stored in a non-volatile memory 528.

Controller 526 also monitors and controls the attenuators 516(1)-516(4) for controlling a power output of each of the attenuators 516 to the distribution units 524. The controller 526 may also be in communication with one or more of the base stations 502, 506, interfaces 510, 512, splitters 514, 520 and distribution units 524 for monitoring inputs of incoming and outgoing communications between the base stations 502, 506 and the receiver units or remote antenna units 504, 508. Monitoring these parameters, inputs and outputs will enable the DAS 500 and the controller 526 to know when service is deteriorating and when a service change is needed.

Detectors may be used for determining presence or absence of power at any of these locations. Sensors, such as power sensors or power level sensors, may be used to determine output or strength of a signal in either direction for any of these devices. The sensors or detectors may be in communication with the controller 526 or with an interface connected to the controller, for monitoring the sensors and detectors, and thus the performance of these parts of the distributed antenna system. The remote antenna units, i.e., the user connections, inputs and outputs may also be monitored to determine their performance and degradation or deterioration of their performance.

FIG. 5 represents the situation where the DAS may be optimized, such as, without or with only low degradation of the QoS and QoE to users in the system, co-channel interferences, or interruption of the communications services. In this situation, Channel 1 from base station 502 is routed in a satisfactory manner through the communication path previously described to remote antenna units 504 in first area 302(1) and Channel 2 from base station 506 is routed in a satisfactory manner through a different communication path to remote antenna units 508 in second area 302(2). For example, switching matrix 522 under the control of controller 526 routes the output of attenuator 516(1), the output being Channel 1, from splitter 514 to distribution units 524 to provide service to remote antenna units 504 in area 302(1). At the same time, attenuator 516(2), which provides an alternative path for a Channel 1 output, is not used, but may be activated to provide an alternative path for Channel 1 if needed. Attenuator 516(3) routes Channel 2 from splitter 520 to remote units in area 302(2), while attenuator 516(4) routes Channel 2 to other sub areas, as noted in FIG. 5. In addition, Channel 1 continues to be routed from the interface 510 to splitter 514 which may split the service and route it to a plurality of attenuators 516(1), 516(2) via pathways 518(1), 518(2). Channel 2 is also routed from its interface 512 to a splitter 520 and then to attenuators 516(3), 516(4) via similar pathways.

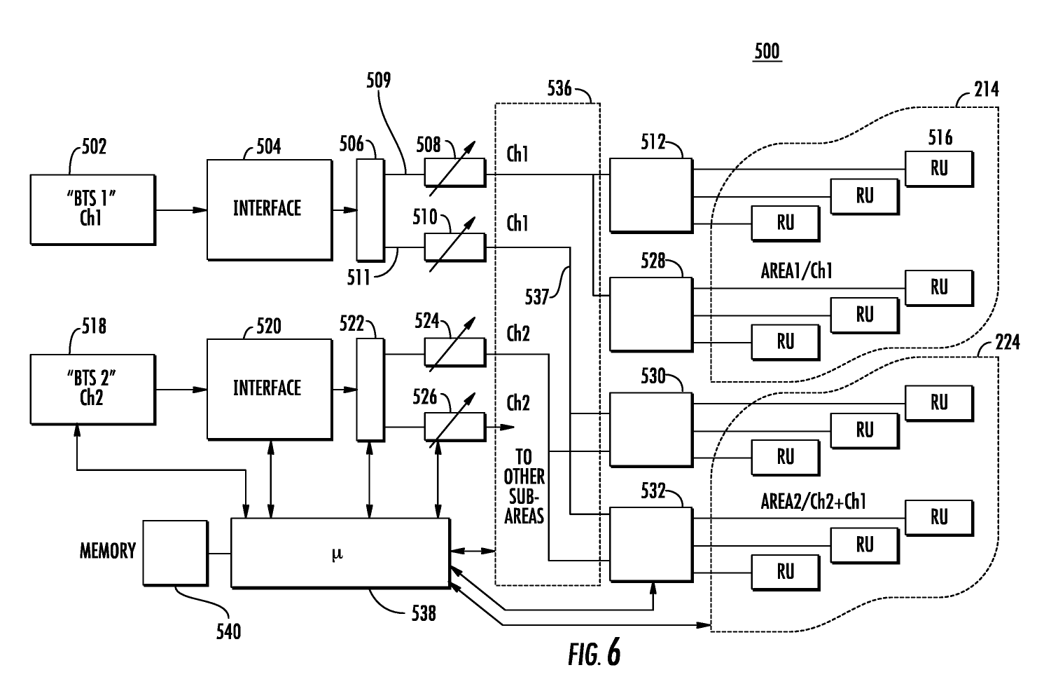

FIG. 6 depicts the DAS 500 in FIG. 5 and a situation in which Channel 2 is no longer the desired channel for use by remote units 508 in area 302(2). For example, the QoS and QoE to users of Channel 2 in the DAS 500 may be diminishing; Channel 2 may be experiencing co-channel interference with another communication channel; there may be an interruption of the communications services provided on Channel 2; or a service provider, an administrator of a DAS, or a self-organized network mechanism has determined that Channel 2 is no longer to be used by remote units 508 in area 302(2), or there is some other reason for discontinuing broadcast of Channel 2. Alternatively, one or more of the components of service between base station 506 and remote units 508 may also be experiencing a difficulty and contributing to degradation of QoS, QoE, co-channel interference or interruption of services. In FIG. 6, controller 526, which is illustratively monitoring the power levels throughout the system, has detected, for example, a QoS and QoE problem and has instructed the DAS 500 to broadcast Channel 1 to the remote units 508 in area 302(2) in addition to the broadcast of Channel 2. Alternatively, a service provider may instruct the controller 526 to discontinue broadcast of Channel 2. In these and other cases, contemporaneously or subsequently, the controller 526 instructs Channel 2 to power down to force the handoff process in the network terminals in area 302(2) to hand off communication between the network terminal and a base station over Channel 1 to communication over Channel 2.

The mechanism for power up and down of a channel may be illustrated as follows. When a deterioration of service is sensed or a service provider, an administrator of a DAS, or a self-organized network mechanism has determined that Channel 2 is no longer to be used by remote units 508 in area 302(2), switching matrix 522 is commanded by controller 526 to switch the Channel 1 output of attenuator 516(2) which is Channel 1 to distribution units 524 depicted in FIG. 5, over path 530. At the same time, the controller instructs attenuators 516(3), 516(4) to power down Channel 2 outputs to distribution units 524. This may be accomplished by first lowering the power of the Channel 2 signal to distribution units 524. For example, controller 526 may command attenuators 516(3), 516(4) to lower their output power from 20 dBm to −100 dBm in a relatively short time period, e.g., 45 seconds. With power from Channel 2 weakened, the remote units 508 or users in area 302(2) are illustratively programmed to automatically handover transmission and reception to new Channel 1, which will be at full power, e.g., 20 dBm in response to the network terminal dropping the communication link with Channel 2 and setting up a communication link with Channel 1 on account of the handoff process protocol employed by the network terminal. The handover occurs by each of the remote antenna units 508 and network terminals tuning their respective transmitter and receiver to Channel 1 as described below. Other power levels may be used in making handovers according to this disclosure.

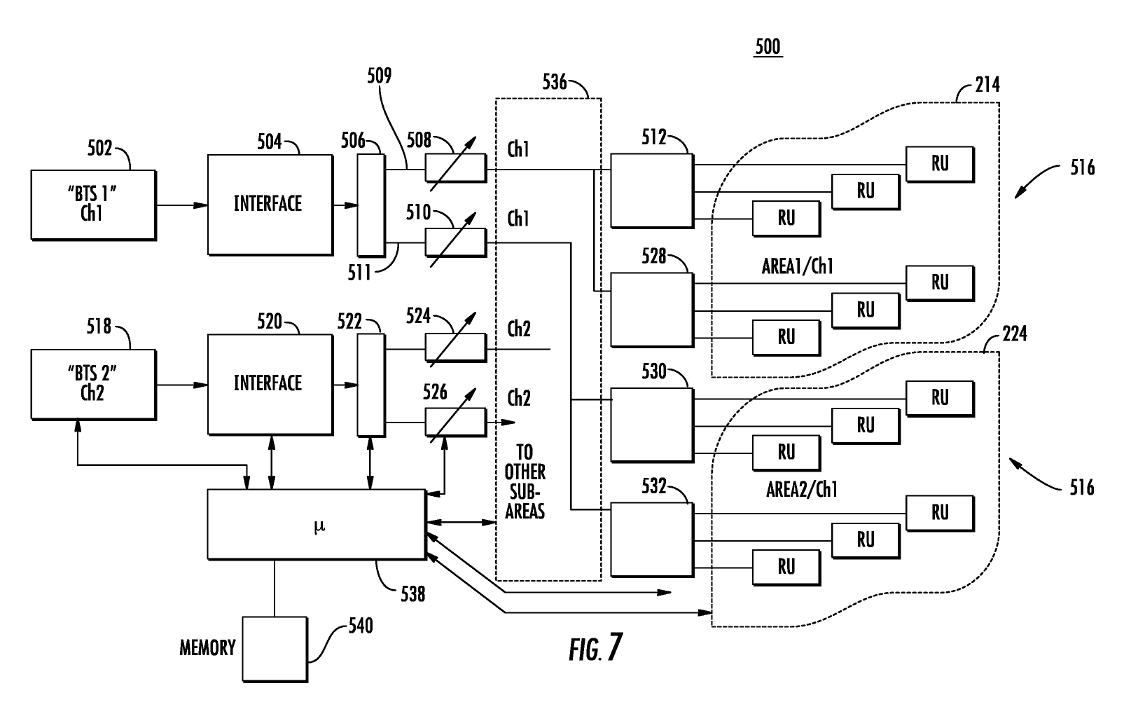

As a result, it is seen in FIG. 6 that the DAS gradually lowers the power of Channel 2 to allow the network terminal to gradually initiate a handover process. When the power of Channel 2 is below a predetermined level, the handover process in the network terminal software automatically hands off the network terminal to Channel 1. After handoff, the DAS 500 then disconnects Channel 2 as illustrated in FIG. 7. In this way, the DAS 500 forces a network terminal in the area to switch between channels that are contemporaneously broadcast into an area in order to optimize the DAS 500.

This principle applies to DASs of any architecture to optimize the DAS without interruption of the communications services. While the illustrative example depicts only two areas, it will be appreciated that the number of areas—one or more (e.g., there are more than two areas, e.g., a building with three floors may have three user areas, as shown in FIG. 1) with which this disclosure may be used is a matter of design. Also, while the illustrative example depicts only two services (e.g., Channel 1 and Channel 2), it will be appreciated that the number of services with which this disclosure may be used is a matter of design. (e.g., three, four or more types of communications service, from among the many possible types of service, as noted above). As already noted, DASs include those with optical fibers, electrical (RF) distribution, and both optical and RF distribution.

In addition, while FIGS. 5-7 have been discussed primarily with respect to analog signals and equipment or remote receiver units or remote antenna units, this disclosure is applicable to digital signals and to digital remote receiver units or remote antenna units. For example, signals in Channel 1 and in Channel 2 may be in a digital format and can be addressed by the equipment in the distribution paths to each user area 302(1), 302(2) and to each remote unit 508. In these instances, routing via the switching matrix 522 is accomplished digitally. Signal attenuation represented by power units or attenuation units 516(1)-516(4) may also be controlled by standard digital control methodologies, e.g., by using an attenuation coefficient rather than by selecting dB signal reduction. For example, signal attenuation may be accomplished over a stated short period of time by applying a sequence of attenuation coefficients of 0.95 to 0.001 during the period of time. Thus, in this example, the Channel 2 strength may change from 95% to 0.00001% over a period of time, as desired and as programmed into the controller.

FIGS. 8-10 are directed to a DAS 600 that may be advantageously used with digital systems, that is, with digital remote antenna units or users of the communications services. A principal advantage of digital communications and routing systems is the ability to select a channel or tune to an alternate channel when a service deteriorates. An exemplary DAS 600 is depicted in FIG. 8. The DAS 600 includes a controller 602 in communication with a memory 604 for storing programs and sequences for the digital DAS 600. In this DAS 600, outside communications services, exemplary Channel 1 and Channel 2, are routed through first and second base stations 606, 608, respectively, to remote units in a first area 610 and a second separate area 612 to a plurality of users 614. The path for signals to and from first base station 606 is through interfaces 616, 618, which may be a HEU 120 as shown in FIG. 2 or other suitable digital interfaces for routing a digital signal.

The signal is routed from the interfaces 616, 618 to digital router 620. In one embodiment, digital router 620 is a digital switching matrix under the control of controller 602. In other embodiments, other switches or switching controllers may be used to route signals to and from base stations 606, 608 to areas 610, 612. In this scenario, digital router 620 or other switching system routes Channel 1 signals along route or pathway 622 to and from distribution unit 624 and Channel 2 signals to and from distribution unit 626 via pathway or route 628 as shown. Distribution units 624, 626 may be optical input modules for converting an electrical downlink output from the base station to optical signals. The distribution units 624, 626 then couple the optical signals through optical fibers from the distribution units 624, 626 to and from remote units in first and second areas 610, 612, respectively. In other embodiments, the distribution units may be suitable for distributing digital electrical communications.

In this embodiment, the digital signals from distribution units 624, 626 are routed to remote units in first and second areas 610, 612. FIG. 8 depicts a plurality of links 630 between distribution unit 624 and first area 610 and also displays a plurality of links 632 between distribution unit 626 and second area 612. Each link 630, 632 may carry a single signal, or with multiplexing or other techniques, it is possible for each link to carry a plurality of signals. In this non-limiting embodiment, only one channel or signal per link is employed. With reference to FIGS. 8-10, the QoS and QoE to users of Channel 2 in the system may be diminishing; Channel 2 may be experiencing co-channel interference with another communication channel; there may be an interruption of the communications services provided on Channel 2; or a service provider, an administrator of a DAS, or a self-organized network mechanism has determined that Channel 2 is no longer to be used by remote units in area 612, or there is some other reason for discontinuing broadcast of Channel 2.

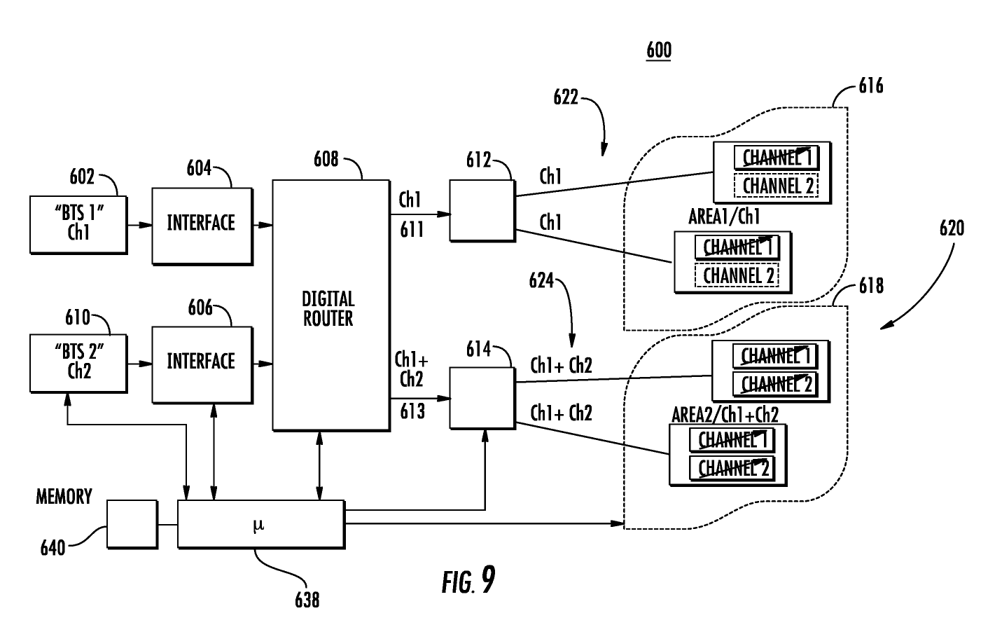

With reference to FIG. 9, controller 602, which is monitoring the power levels illustratively throughout the DAS 600, has detected the deterioration and has commenced to switch service in second area 612 from Channel 2 to Channel 1. Controller 602 detects the deterioration from one or more detectors or sensors. Alternatively, a service provider may instruct the controller 602 to discontinue broadcast of Channel 2. Controller 602 commands digital router 620 to add Channel 1 to route 628 to distribution unit 626 and to second area 612. Distribution unit 626 now routes both Channel 1 and Channel 2 signals to second area 612. In other words, both Channel 1 and Channel 2 are being broadcast to area 612. At this point in time, a network terminal in area 612 is communicating with a base station 608 over Channel 2. Contemporaneously or subsequently, controller 602 commands the Channel 2 broadcast inform each remote unit of second area 612 to gradually lower their output power. In one example, the controller may command each remote unit in second area 612 to go from nominal power of 20 dBm to −100 dBm in a short period of time, e.g., 45 seconds. Since the output for Channel 2 is dramatically weakened and a signal from Channel 1 is readily available, each network terminal will automatically hand over communication between the network terminal and the base station to the new channel, Channel 1. Specifically, the handover occurs by each of the remote units and network terminals tuning their respective transmitter and receiver to Channel 1 as described below.

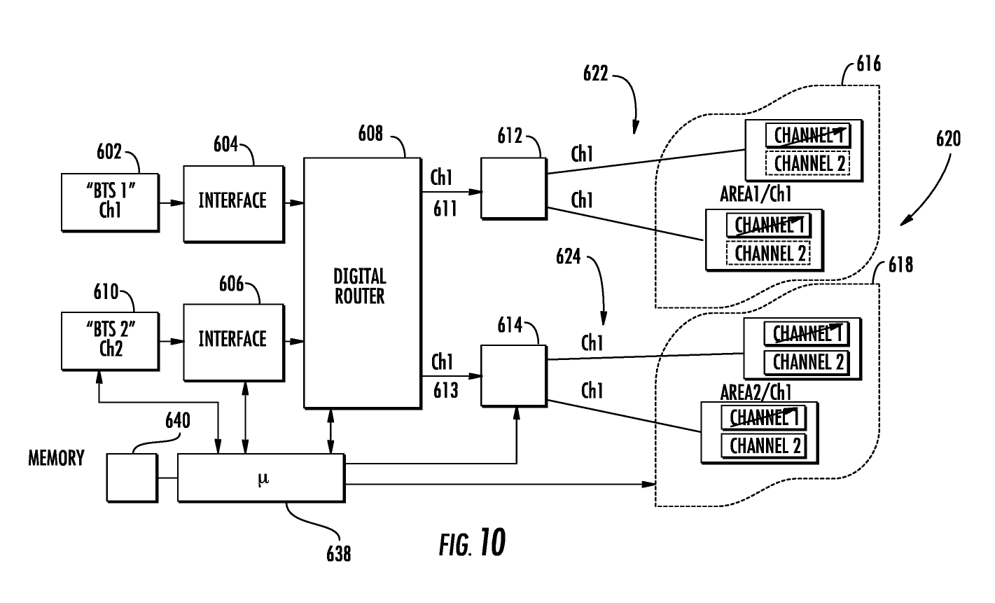

After handoff, the DAS 600 then disconnects Channel 2 as illustrated in FIG. 10. In this way, the DAS 600 forces a network terminal in the area 612 to switch between channels that are contemporaneously broadcast into the area 612 in order to optimize the DAS 600.

With reference back to FIGS. 5-7, in analog remote antenna units, the DAS 500 cannot distinguish between channels; only between frequency bands. If Channel 1 and Channel 2 are in the same frequency band, the power down cannot be executed by the remote unit 508. Rather, the power down occurs centrally by attenuators 516 shown in FIG. 5.

In contrast, in digital antenna units, such as DAS 600, the DAS can distinguish between channels and frequency bands. For that reason, the power down in a digital remote antenna unit can be performed centrally at the HEU as well as at the remote antenna unit.

FIG. 11 is a flowchart illustrating a method 1100. A first channel is routed to a predetermined area at a predetermined power level. The first channel provides a service to at least one network terminal in the predetermined area (block 1102). A second channel is also routed to the predetermined area at a power level lower than the predetermined power level of the first channel (block 1104). A power level of the first channel is lowered to trigger handoff of the communications service to the at least one network terminal from the first channel to the second channel (block 1106).

A flowchart in FIG. 12 depicts an exemplary method for handoff in a DAS. The handover occurs by each of the remote antenna units and network terminals tuning their respective transmitter and receiver to Channel 1 as described below. As shown in this method 1200, a remote antenna or network terminal initially has transmitter and receiver tuned to a second communication traffic channel (block 1202). The network terminal detects a loss in power of a second channel and communicates this power loss to an associated remote antenna unit. When the power of the second channel at the network terminal falls below the power level of the first channel controller, the network terminal may generate an RU Tuning Instruction Message (RU TIM) including an instruction for the RU to tune its transmitter and receiver to the second channel (block 1204). In addition, or alternatively, the remote antenna unit may generate a Tuning Instruction Message (TIM) including an instruction for the network terminal to tune its transmitter and receiver to the second channel as also depicted in step 1203.

The device tunes to the new channel, which is the first channel in this example (block 1206). The device turns off its transmitter and tunes its receiver to the new channel which is the first channel in this example (block 1208). The device turns its transmitter back on (block 1210). The device is now receiving a communication channel at the tuned frequency (e.g., the first communications channel) (block 1212). The device sends a message confirming reconfiguration of the device to transmit and receive on the first communication channel as the traffic channel (block 1214).

The handoff process occurring between a network terminal and a remote antenna unit as described in connection with FIG. 12 is responsive to the handoff process which generally entails first contemporaneously broadcasting a first channel and a second channel to an area; second, gradually lowering the power of the first channel in order to trigger handoff to the second channel in accordance with the handoff process occurring between the network terminal and the remote antenna, and third, after handoff, disconnecting the first channel. This is an illustrative way in which a DAS may, according to this disclosure, force a network terminal in the area to switch between channels that are contemporaneously broadcast into an area in order to optimize the DAS.

In view of this disclosure, it will be seen that technologies are generally described for optimizing communications services within an area or a building served by a distributed antenna system. There is thus disclosed a method for triggering channel handoffs in a DAS. A first channel is routed to a predetermined area at a predetermined power level. The first channel provides a service to at least one network terminal in the predetermined area. A second channel is routed to the predetermined area. A power level of the first channel is lowered to trigger handoff of the service to the at least one network terminal from the first channel to the second channel.

The step of the routing a second channel to the predetermined area may occur at a power level lower that is about the same power level as the predetermined power level of the first channel. The step of lowering a power level of the first channel further comprises the steps of raising a power level of the second channel, or both lowering the power level of the first channel and raising the power level of the second channel.

The method described above may further include the step of disconnecting the first channel to the predetermined area after a period of time that allows handoff of the service to the second channel. The step of lowering a power level of the first channel to trigger handoff of the service occurs over a period of time between about five and sixty seconds. The step of lowering a power level of the first channel to trigger handoff of the service may occur gradually.

The first channel may be a first channel and the method may further comprise: identifying interference between the first channel routed to the predetermined area and a second first channel broadcast to the predetermined area; and the step of lowering a power level of the first channel to trigger handoff of the service to the second channel occurring upon identifying the interference.

The method may further include the step of receiving notification from a service provider to handoff the first channel routed to the predetermined area; and the step of lowering a power level of the first channel to trigger handoff of the service to the second channel occurring upon receipt of the service provider notification.

The method may further include the step of: receiving notification from an entity based upon a performance evaluation conducted in a building to handoff the first channel routed to the predetermined area; and the step of lowering a power level of the first channel to trigger handoff of the service to the second channel occurring upon receipt of the notification from the entity.

The method may further include the step of: receiving notification from a self-organized network mechanism to change the first channel routed to the predetermined area; and the step of lowering a power level of the first channel to trigger handoff of the service to the second channel occurring upon receipt of the self-organized network mechanism notification. The self-organized network mechanism notification may be based upon criteria selected from the group consisting of planning, deployment configuration, coverage considerations, capacity considerations, network configuration, and operational needs. The self-organized network mechanism notification may be based upon service or availability optimization.

The step of lowering a power level of the first channel to trigger handoff of the service to the second channel may occurs at a head end unit (HEU). The step of lowering a power level of the first channel to trigger handoff of the service to the second channel may occur at a remote antenna unit (RAU).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method for triggering channel handoffs in a wireless communications system, the method comprising:
routing a first channel of a communications service to a predetermined area in the wireless communication system at a predetermined power level, the first channel providing a service to at least one network terminal in the predetermined area in the wireless communication system;
routing a second channel of the communications service to the predetermined area in the wireless communication system; and
lowering a power level of the first channel to trigger handoff of the service to the at least one network terminal from the first channel to the second channel.

2. The method of claim 1, wherein routing the second channel to the predetermined area occurs at a power level that is about the same power level as the predetermined power level of the first channel.

3. The method of claim 2, wherein lowering the power level of the first channel further comprises the steps of raising a power level of the second channel, or both lowering the power level of the first channel and raising the power level of the second channel.

4. The method of claim 3, further comprising:
disconnecting the first channel to the predetermined area after a period of time that allows handoff of the service to the second channel.

5. The method of claim 1, wherein lowering the power level of the first channel to trigger handoff of the service occurs over a period of time between about five and sixty seconds.

6. The method of claim 1, further comprising:
identifying interference between the first channel routed to the predetermined area and the second channel broadcast to the predetermined area; and
wherein lowering the power level of the first channel to trigger handoff of the service to the second channel occurs upon identifying the interference.

7. The method of claim 1, further comprising:
receiving notification from a service provider to handoff the first channel routed to the predetermined area; and
lowering the power level of the first channel to trigger handoff of the service to the second channel occurs upon receipt of the notification from the service provider.

8. The method of claim 1, further comprising:
receiving notification from an entity based upon a performance evaluation conducted in a building to handoff the first channel routed to the predetermined area; and
lowering the power level of the first channel to trigger handoff of the service to the second channel occurs upon receipt of the notification from the entity.

9. The method of claim 1, further comprising:
receiving notification from a self-organized network mechanism to change the first channel routed to the predetermined area; and
lowering the power level of the first channel to trigger handoff of the service to the second channel occurs upon receipt of the notification from the self-organized network mechanism.

10. The method of claim 9, wherein the notification from the self-organized network mechanism is based upon criteria selected from the group consisting of: planning, deployment configuration, coverage considerations, capacity considerations, network configuration, and operational needs.

11. The method of claim 10, wherein the notification from the self-organized network mechanism is based upon service or availability optimization.

12. A wireless communication system, comprising:
a router configured for routing a plurality of channels of a communications service to a predetermined area in the wireless communication system, the router configured to:
route a first channel to a predetermined area at a predetermined power level, the first channel providing a service to at least one network terminal in the predetermined area in the wireless communication system; and
upon command, route a second channel of the communications service to the predetermined area in the wireless communication system; and
a controller configured for controlling the routing of the plurality of channels of service and for controlling lowering a power level of the first channel to trigger handoff of the service to the at least one network terminal from the first channel to the second channel.

13. The wireless communication system of claim 12, wherein the controller is further configured to control disconnection of the first channel to the predetermined area after handoff of the service to the second channel.

14. The wireless communication system of claim 12, wherein the router comprises a splitter, a power control element, and a switching matrix, and wherein the power control element is a device configured to adjust a power level of a signal.

15. The wireless communication system of claim 14, wherein the switching matrix comprises a plurality of switches disposed between a plurality of base stations and a remote unit configured for routing a plurality of channels of service from the plurality of base stations to the remote unit.

16. The wireless communication system of claim 12, further comprising a distribution unit configured to convert one of the plurality of channels of service into an optical channel for transmission to a remote unit, wherein the distribution unit is an electrical to optical media converter.

17. The wireless communication system of claim 12, further comprising one or more detectors, and executable instructions in a memory for determining the lowering the power level of the first channel to trigger handoff of the service to the at least one network terminal from the first channel to the second channel.

18. The wireless communication system of claim 12, wherein the service is a radio-frequency service selected from the group consisting of: a telephone service, an internet service and a radio service.

19. The wireless communication system of claim 12, wherein the service is selected from the group consisting of: cellular services such as CDMA, TDMA, GSM, WiMAX, LTE of cellular generations 2G, 3G, 4G, 5G or wireless local area network (WLAN) services such as WiFi, or other wireless technologies such as Bluetooth and Zigbee, and wherein the wireless communication system is further configured to serve a geographic area selected from the group consisting of: a building, an area of a building and one or more rooms of a building.

20. The wireless communication system of claim 12, further configured to:
identify interference between the first channel routed to the predetermined area and the second channel broadcast to the predetermined area; and
lowering the power level of the first channel occurring upon identifying the interference.
